(19) United States
(12) Patent Application Publication
(10) Pub. No.: US 2013/0284869 A1
(43) Pub. Date: Oct. 31, 2013

(54) METHOD AND APPARATUS FOR CONVEYING TOOLS TO WORK SITE ALONG AN ELONGATED OBJECT AND USE OF THE APPARATUS

(71) Applicant: Mauri Helenius, Helsinki (FI)

(72) Inventor: Mauri Helenius, Helsinki (FI)

(73) Assignee: MECLIMB OY, Helsinki (FI)

(21) Appl. No.: 13/977,304

(22) PCT Filed: Dec. 21, 2011
(86) PCT No.: PCT/FI11/51147

§ 371 Date: Jul. 17, 2013

(30) Foreign Application Priority Data
Dec. 30, 2010 (FI) 20106390

(51) Int. Cl. F16M 13/02; A01G 23/095; A01G 23/08; H02G 1/02; B23P 6/00

(52) U.S. Cl. CPC F16M 13/022; H02G 1/02; B23P 6/00; A01G 23/08; A01G 23/0955
USPC 248/218.4; 29/825; 29/407.04; 29/402.01; 144/336; 144/343; 29/650

(57) ABSTRACT

The object of the invention is a method and an apparatus for conveying tools to a work site along an elongated object, such as along a pillar, a post, a beam or a tree. The apparatus is provided with at least a control system and comprises at least a work device connected to the control system and moving along an elongated object, said work device comprising a frame and moving means for controlling the work device up and down along the elongated object. The frame of the work device consists of two frame halves to be disposed around the elongated object and to be locked to each other, to which frame halves a tool base is fixed for at least the tools needed at the work site.

The object of the invention is a method as defined in the preamble of claims 1 and an apparatus as defined in the preamble of claim 6 for conveying tools to a work site along an elongated object, and also use of the apparatus as defined in the preamble of claim 16.

The solution according to the invention is particularly well suited to e.g. the disassembly, repair or installation of electricity lines, in which tasks the apparatus is arranged to take the necessary tools up an electricity pillar and e.g. to detach the electrical wires and the crossbar of the pillar when disassembling the electricity lines. In addition, the solution is also very well suited to the painting of different pillars, such as erect lighting pillars, and also to the cleaning and painting of various beams, such as the beams of bridges. The apparatus is also suited for trimming the branches of erect trees and cutting the trunk of erect trees.

According to prior art, the repair work and disassembly work of electricity lines on electricity pillars has been performed such that an employee himself/herself climbs the pillar taking the necessary tools with him/her. One problem in this case has been the safety of the work. The employee can fall from the pillar because of human error or the whole pillar can fall, in which case fatal cases are not always avoided. Electricity pillars have fallen e.g. in connection with the disassembly of electricity lines, when after the detachment of the electricity wires the pillar without the additional support of the electricity wires has unexpectedly toppled or its bottom part has snapped. The reason has been a pillar that has decayed, or been lifted by groundfrost, and the load of the employee on only one side of the pillar producing an imbalance. When the support provided by the electricity wires is removed, the support of the pillar is insufficient and an accident occurs.

Efforts have been made to eliminate this problem by handling the disassembly of electricity lines e.g. by the aid of a hydraulic platform vehicle. In this case an unbalanced load is not exerted on the pillar, nor does the snapping or falling of the pillar otherwise cause the same type of danger to people as if the pillar were climbed. One problem, however, is that a hydraulic platform vehicle cannot be used elsewhere than in passable terrain. In rough forest terrain a hydraulic platform vehicle cannot be used for the disassembly of electricity lines. Another problem is that when using a hydraulic platform vehicle in streets and on roads, other dangerous situations also arise, because e.g. one of the driving lanes must be closed during the work owing to the large-sized hydraulic platform vehicle.

The aim of this invention is to eliminate the aforementioned drawbacks and to achieve an inexpensive, simple, fast and safe method and apparatus for conveying tools to a work site along an elongated object, such as a pillar, a post or a beam by the aid of which apparatus a job required can be performed at the work site, at the top end of a pillar, or elsewhere on the pillar or beam by the aid of the tools. In addition, another aim of the invention is to achieve an inexpensive, fast, easy-to-use and safe solution for using the apparatus in different working tasks, such as in the installation work, repair work and disassembly work of electricity lines and in the repair work, cleaning work and painting work of various pillars or beams. The method according to the invention is characterized by what is presented in the characterization part of claim 1. Correspondingly, the apparatus according to the invention is characterized by what is disclosed in the characterization part of claim 6, and use of the apparatus according to the invention is characterized by what is disclosed in the characterization part of claim 16. Other embodiments of the invention are characterized by what is disclosed in the other claims.

One advantage of the solution according to the invention is that it enables safe working high up on various pillars and beams. By means of the solution according to the invention e.g. disassembly work, repair work and installation work of electricity lines can be performed in such a way that people do not need to climb electricity pillars. Another advantage is that it is possible to do various jobs on electricity pillars also in a powered network, because people do not need to climb electricity pillars. Likewise, the cleaning and painting work of various posts or pillars, such as lighting pillars, and various beams, such as the beams of a bridge, can be performed such that people do not need to climb to the work sites, but instead the work can be done safely from the ground by the aid of remote control. Another advantage also is that work can also be performed at sites in rough terrain, to which sites e.g. a hydraulic platform vehicle cannot gain access. Another advantage is also that the traction rollers used in the apparatus do not break the surface of the pillar and grip the pillar well, and it is easy to replace the traction rollers to be the best suited according to the properties of the surface of a pillar or according to the shape and size of a pillar. Yet another advantage of the apparatus is the inexpensive, simple and light structure, in which case the device is easy to deliver to the workplace and which device carries the necessary tools reliably along a pillar or beam to the work site.

In the following, the invention will be described in more detail by the aid of two examples of its embodiment with reference to the attached drawings, wherein

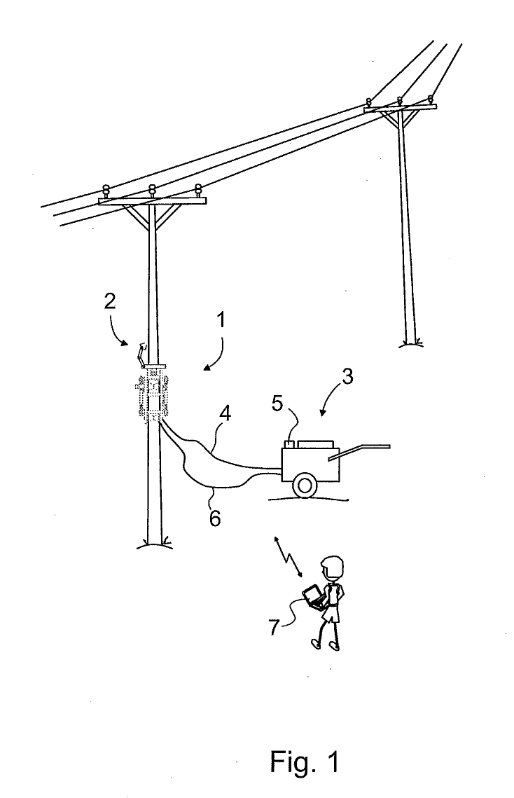

FIG. 1 presents a situation in which an electricity line is disassembled with the method and apparatus according to the invention,

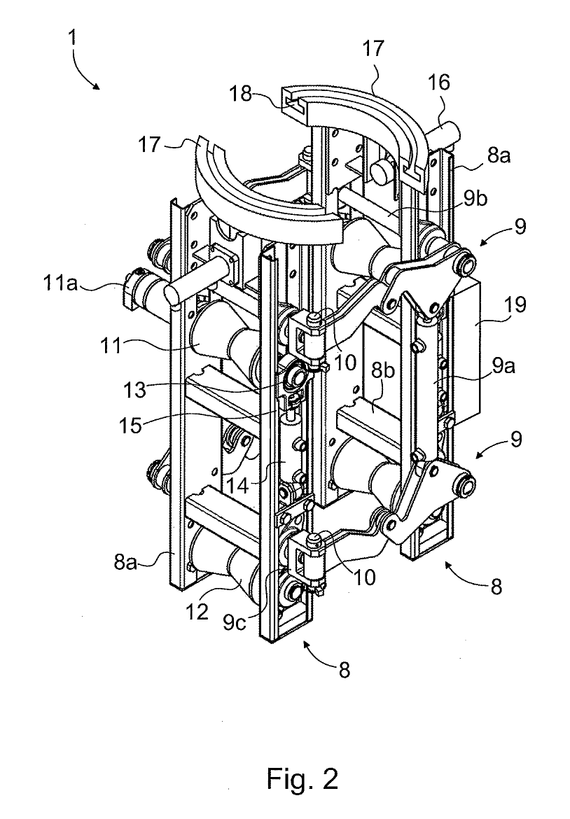

FIG. 2 presents a work device according to the invention, taking tools to a pillar, viewed obliquely from the side and from the top,

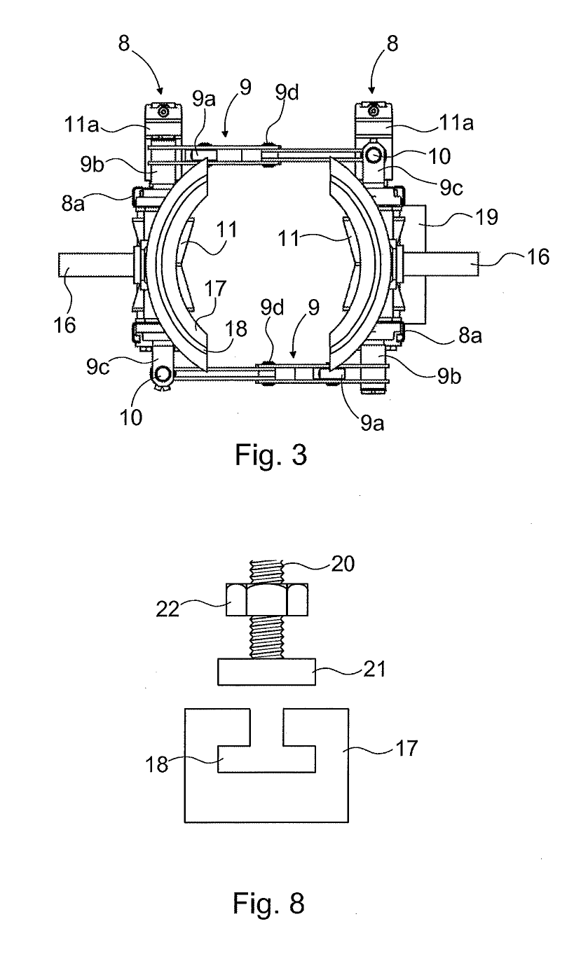

FIG. 3 presents a top view of a work device according to the invention, taking tools to a pillar,

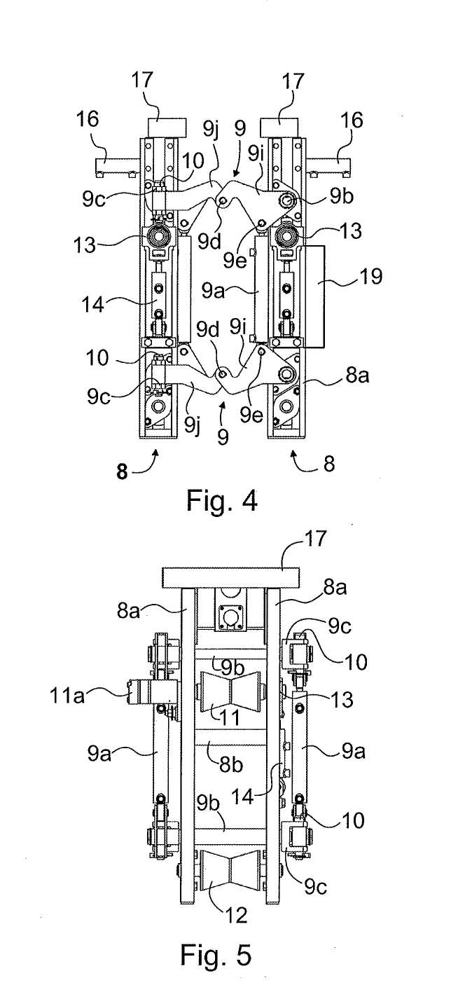

FIG. 4 presents a side view of a work device according to the invention, taking tools to a pillar, said work device being in its widest position,

FIG. 5 presents a front view of a work device according to the invention, taking tools to a pillar,

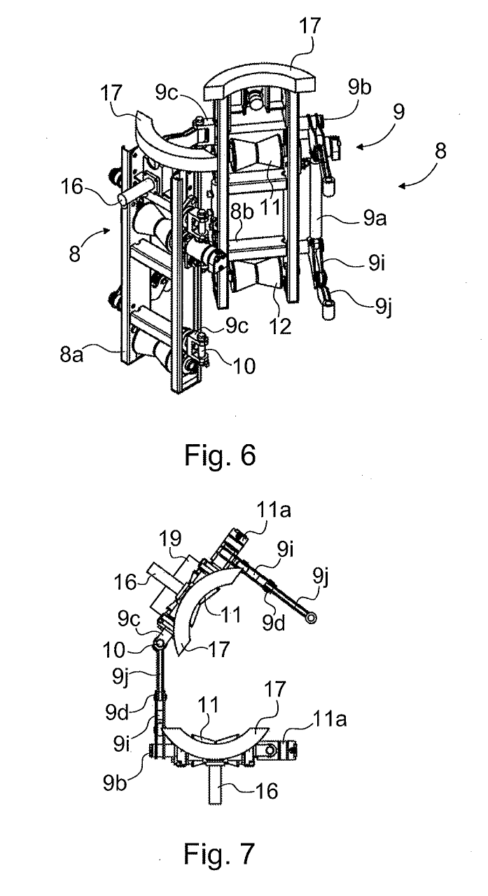

FIG. 6 presents a work device according to the invention, taking tools to a pillar, viewed obliquely from the side and from the top when opened at one side,

FIG. 7 presents a top view of a work device according to the invention, taking tools to a pillar when opened at one side,

FIG. 8 presents a diagrammatic and simplified detail of the fixing of tools to a work device according to the invention,

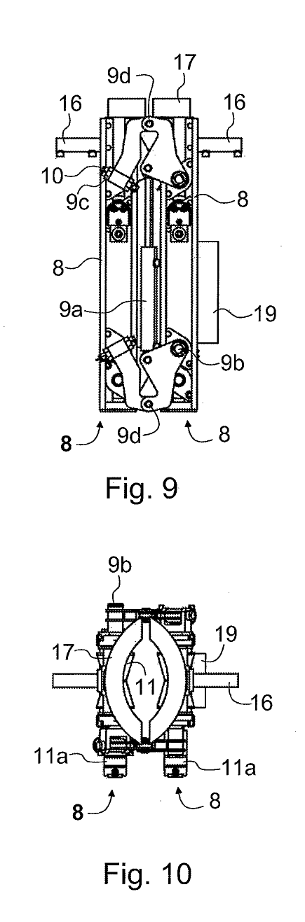

FIG. 9 presents a side view of a work device according to the invention, taking tools to a pillar, said work device being in its narrowest position,

FIG. 10 presents a top view of a work device according to the invention, taking tools to a pillar, said work device being in its narrowest position, and

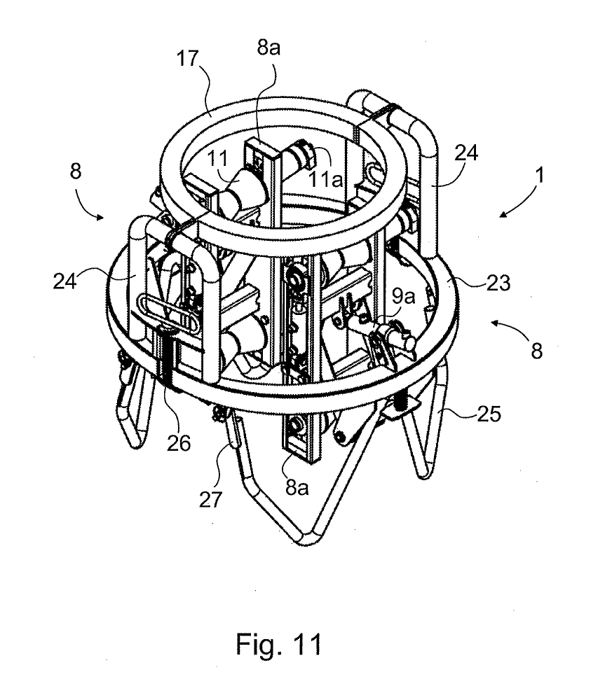

FIG. 11 presents a second work device according to the invention, taking tools to a pillar, viewed obliquely from the side and from the top.

FIG. 1 presents a situation in which an electricity line is disassembled with the method and apparatus according to the invention. The electricity line could just as well be being serviced or installed. A work device 1 according to the invention is fitted around an electricity pillar or electricity post, which work device is arranged to rise up along the pillar and to take along with it as it goes to the work site at the top end of the pillar the tools 2 fixed to it that are needed in the work to be performed up above. The work device 1 is fitted from two frame halves around the pillar either by manpower or with a separate remote-controlled transport device, which is not presented in the figures. The transport device to be remotely controlled comprises, in addition to other actuators, working lights and a video camera, which enable accurate placement of the work device 1 by the aid of remote control into the correct position around the pillar in all conditions.

The work device 1 is connected to a hydraulic powerpack 3 via hydraulic hoses 4. In addition, a current source 5, such as e.g. a generator and/or battery pack, is fitted in connection with the hydraulic powerpack 3, which current source 5 is connected with electric cables 6 to the work device 1. The parts of the work device 1 needing electricity, such as the control system and the working lights that are actuators as well as a possible video camera, receive the necessary control current and operating current from a current source 5 along the electric cables 6. The transport device and the work device 1 are controlled by remote control with a control unit 7 belonging to the arrangement. The construction and the different parts of the work device 1 are presented in more detail in the figures below.

The portable control unit 7 comprises controllers, with which the functions of the work device 1, of the transport device and of the hydraulic powerpack 3 are controlled by remote control. In addition, the control unit 7 comprises a display, from which a user of the control unit 7 can monitor, inter alia, the video image filmed by the video cameras on the transport device and on the work device 1. By monitoring the image of the video camera of the transport device, a user of the control unit 7 is able to control the work device 1 to the pillar by the aid of the transport device and to position the work device 1 around the pillar. By monitoring the image of the video camera of the work device 1, it is possible in turn to monitor the progress of the work device 1 along the pillar and the work to be performed at the work site.

FIG. 2 presents one work device 1 according to the invention, taking tools to a pillar. The device 1 comprises at least a two-part frame, which comprises two frame halves 8 that are essentially similar to each other and disposed opposite to each other, each of which frame halves comprises e.g. two vertical beams 8a at a distance from each other and the cross members 8b disposed between them. In addition, both frame halves 8 comprise two hinge pins 9b disposed transversely with respect to the vertical beams 8a, which hinge pins are longer than the horizontal distance between the vertical beams 8a of the frame half 8 and extend from one frame beam to the other and which hinge pins are mounted via bearings on both vertical beams 8a such that both ends of the hinge pin 9b extend to outside the vertical beams 8a.

Both frame halves 8 further comprise a traction roller 11 provided with a hydraulic drive machinery 11a and functioning as a traction means, which traction roller is mounted on bearings to rotate around its longitudinal axis between the vertical beams 8a of the frame half 8. Correspondingly, below the traction roller 11 is a guide roller 12, which is also mounted on bearings to rotate around its longitudinal axis between the vertical beams 8a of the frame half 8. The rollers 11 and 12 are conical such that the diameter of the rollers is largest at the ends of the rollers and the diameter decreases conically towards the center point in the axial direction of the rollers, and the diameter of the rollers is smallest at the center point in the axial direction of the rollers. The traction roller 11, or at least the surface of the traction roller, is of rubber or of a corresponding material possessing a good friction grip, the hardness of which is e.g. between 55-80 Shore A, suitably between 60-70 Shore A and preferably approx. 65 Shore A. Correspondingly, the guide roller 12, or at least the surface of the guide roller, is of plastic or of some other corresponding material.

The second end of the traction roller 11 is mounted in a bearing 13 that is movable along one vertical beam 8a for inclining the axis of rotation of the traction roller 11, which inclining is implemented with power means 14, such as with a hydraulic cylinder, which is disposed in the second vertical beam 8a longitudinally to the vertical beam. On the edge of a vertical beam 8a are guide rails 15 for guiding the bearing housing of the bearing 13 to travel on the vertical beam 8a. The work device 1 is controlled to rotate around the pillar by inclining the traction rollers 11.

In addition, both frame halves 8 further comprise locking means 16, by the aid of which the work device 1 is locked into position on the pillar for the duration of the working on the pillar. The locking means 16 comprise e.g. a hydraulic actuator, such as a hydraulic cylinder and a rubber-surfaced locking piece at the end of the piston, which locking piece when locking the device presses against the pillar.

The top part of each frame half 8 further comprises a tool base 17, to which the tools to be used are fixed. The tool base 17 is e.g. as viewed from the top a curved beam curving around the pillar, the top surface of which beam contains a fixing groove 18, e.g. a T-shaped groove, for the fixing of tools.

The frame halves 8 are disposed opposite to each other and connected to each other with four hinge mechanisms 9, of which two are one below the other on both sides of the device. The hinge mechanisms 9 of one side are fixed at their first end to the first end of the hinge pins 9b of the first frame half 8a. Correspondingly, the aforementioned hinge mechanisms 9 are locked at their second end to a locking means 9c at the second end of the hinge pins 9b of the second frame half by means of locking pins 10. The locking means 9c comprises two essentially similar fixing brackets at a distance from each other, in the holes of which the pins 10 are disposed. The hinge mechanisms 9 on the second side of the device 1 and their lockings are similar, but implemented as mirror images. On both sides of the device 1 a hydraulic power means 9a, such as a hydraulic cylinder, is disposed between the hinge mechanisms 9 for moving the hinge mechanisms 9 and for moving the frame halves 8 towards each other and away from each other, in which case also the traction rollers and guide rollers 11, 12 move towards each other and away from each other. In this way the work device 1 is tightened around the pillar and is also detached from it with a movement of the power means 9a in the direction of the vertical beams 8a.

On the rear side of the work device 1 on the second frame half 8 is a control cubicle 19, which is not presented in all the figures. Most of the components, such as hydraulic valves and other control logic as well as the necessary electronics, such as the remote control receiver, of cetera, needed for the control and operation of the work device 1 are assembled so that they are protected in the control cubicle 19. The hydraulic hoses 4 and electric cables 6 between the hydraulic powerpack 3 and the work device 1 are fixed first to a frame half 8 of the work device 1 to a supporting point and led from there without tension to the control cubicle 19. The control cubicle 19 also contains the necessary hydraulic connectors and electrical connectors for the tools 2. The fixing points and the hydraulic connectors and electrical connectors are not shown in the figures.

The work device in FIGS. 3-7 is presented in different positions as viewed from above and from the sides and also with the frame halves 8 connected to each other and detached from each other. The hinge mechanism 9 comprises two hinge arms 9i and 9j, which are hinged to each other with a hinge 9d, which is disposed between the frame halves 8. The first end of the first hinge arm 9i is fixed to the first end of the hinge pin 9b so as to rotate along with the hinge pin 9b. Correspondingly, the second end of the first hinge arm 9i is hinged to the first end of the second hinge arm 9j by the aid of the aforementioned hinge 9d. In addition, one side of the frame half 8 has a locking means 9c rotating along with the hinge pin 9b on the second end of the hinge pins 9b, into the fixing brackets of which locking means the second end of the second hinge arm 9i is locked with a locking pin 10. In this way the hinge mechanism 9 keeps the frame halves 8 together. There are two hinge mechanisms 9, one below the other, as mentioned earlier, and between the hinge mechanisms 9 is a hydraulic power means 9a, which is arranged to lengthen and to shorten in the direction of the vertical beams 8a of the frame halves. The hydraulic cylinder that is the power means 9a is hinged at both its ends between the first hinge arms 9i with a hinge 9e, the position of which in the horizontal direction is between the hinge 9d that is between the hinge pin 9b in the frame half 8a and the hinge arms 9i, 9j. In addition, the position of the hinge 9e is, in all the positions of the hinge mechanisms 9, to the side of a straight line between the hinge pin 9b and the hinge 9d. Thus the power means 9a and the line in the direction of the force produced by it are to the side of the center line between the frame halves 8, i.e. from the vertical center line of the work device 1.

According to the above, the shape of the hinge mechanisms 9 and the positions of the fixing points of their ends as well as the positions of the hinges 9d and 9e are selected to be such that the compressive force of the rollers 11 and 12 on the pillar produced by the power means 9a is essentially the same in all positions of the hinge mechanisms 9, in which case the rollers 11, 12 press against pillars of all thicknesses with essentially the same force. This makes it easy to control the compressive force of the rollers 11, 12.

FIG. 8 presents in diagrammatic and simplified form one detail of the fixing of tools 2 to a work device 1 according to the invention. The tool base 17 contains e.g. a groove 18 that is T-shaped in its cross-section, into which groove the stem part 20 of each tool 2 can be fastened. The stem part 20 of a tool comprises a detent 21, which can be fitted into the desired point in the groove 18 from the free end of the tool base 17 and can be fixed into position by the aid of a fixing nut 22 or corresponding fixing means. The fixing method described is one type of rapid quick-fastening and by the aid of it tools can easily be fastened into the right point. Quick-fastening can also be implemented in some other suitable manner. In addition, the tools 2 are connected to the control system and electrical system of the work device 1, and hydraulic tools are also connected to the hydraulic system of the work device. The work device 1 and the tools 2 are controlled by remote control by the aid of a portable control unit 7.

In FIGS. 9 and 10 the work device 1 according to the invention is presented in its most narrow position of all, in which position it can climb very thin pillars. In this case the length of the power means 9a is as large as possible and the power means 9a has turned the outer ends of the lever mechanism 9 to as close to each other as possible, in which case the horizontal distance between the traction rollers and guide rollers 11, 12 is at its shortest. This type of structure is practicable e.g. when cleaning and painting thin lighting pillars.

FIG. 11 presents a second work device 1 according to the invention, taking tools 2 to a pillar. The work device according to FIG. 11 is larger in size than the work device mentioned above earlier. This work device 1 also comprises two frame halves 8, which are locked to each other around the pillar with locking means 26 such that the pillar remains in the center of the frame halves 8. Both frame halves 8 comprise two vertical beams 8a, which form an essentially similar structure to the vertical beams of the work device mentioned above earlier. In this case between the vertical beams 8a essentially similar traction rollers 11 and guide rollers 12 as presented earlier are mounted on bearings, and also an essentially similar mechanism for inclining the traction rollers 11 for rotating the work device 1 around the pillar.

A difference to the construction of the work device presented above is, however, that the tool base 17 in both frame halves 8 in the work device presented by FIG. 11 is an essentially semicircular structure that is stationary in the lateral direction. In addition, both the frame halves 8 of the work device according to FIG. 11 comprise an essentially semicircular ring structure 23 that is stationary in the lateral direction, which is arranged to support the frame half 8. The ring structure 23 further comprises an additional support structure 24, which is fitted to support the tool base 17 and the locking means 26 of the frame halves. The bottom surface of the ring structure 23 has legs 25 pointing downwards from the bottom surface.

Yet another difference to the construction of the work device presented above is that the hydraulic cylinders functioning as the power means 9a in the work device according to FIG. 11 are fixed at their first end to the ring structure 23 and at their second end to the structure formed by the vertical beams 8a and thus fitted directly between the structure formed by the ring structure 23 and the vertical beams 8a to move the structure formed by the vertical beams 8a, and along with it the traction rollers and guide rollers 11, 12, directly towards the pillar and away from the pillar. Thus compression of the rollers 11, 12 onto the pillar is done without the lever mechanism described above and is easy to keep essentially constant with all pillar thicknesses. The structure formed by the vertical beams 8a in the construction according to FIG. 11, together with its traction rollers and guide rollers 11, 12, is therefore moved towards the pillar and away from the pillar, whereas the tool base 17 and the ring structure 23 remain essentially stationary in the direction of the pillar. Movement in the longitudinal direction of the pillar is implemented with a hydraulic drive machinery 11a, which is configured to rotate both traction rollers 11 in the same way as in the work device described above.

A common structure in both the device solutions presented is a spring-loaded switch means 27, which detects the collision of the bottom end of the work device 1 with the ground or with another base when the work device 1 is descending to the root of the pillar. The switch means 27 is disposed e.g. on the bottom end of the vertical beam structures 8a or in connection with the legs 25 of a device provided with separate legs 25, and is connected to the control system of the apparatus, which control system stops the rotation of the traction rollers 11 when the work device 1 collides with the ground or with another base. Another common structure is the easy fixing of the traction rollers and guide rollers 11, 12 into their position, in which case the traction rollers and guide rollers are replaceable and can be easily replaced. In this way rollers of different sizes and of different shapes, and also provided with different surfaces, can easily be used in connection with different pillars.

All the hydraulic actuators presented above, or at least a part of them, can also be electrically-operated actuators, such as e.g. spindle motors, and instead of a hydraulic powerpack 3 and/or current source 5 on the ground the work device 1 can be provided with its own chargeable current source for giving current to all the actuators of the work device 1, such as one or more accumulators, which can be easily fixed in connection with the work device 1 to travel along with the work device 1 when the work device 1 travels along an elongated object. In this way the work device 1 can operate under remote control as a wireless and hoseless unit.

With the method according to the invention tools are carried along an elongated object, such as a pillar or beam, to a work site e.g. as follows: the work device 1 is brought e.g. to a pillar either by manually carrying it or with a transport device, suited for the purpose, to be remotely controllable with a control unit 7. When bringing the work device 1, the frame halves 8 can be detached from each other or attached to each other e.g. at only one side. The weight of one frame half 8 is dimensioned to be such that one or two people together can manage to carry a frame half 8 from the transport vehicle to the root of the pillar. When the work device 1 is at the root of the pillar, it is disposed around the pillar either with the control unit 7 with the remote-controlled transport device or by manpower each frame half 8 at a time and the frame halves 8 are locked to each other with the locking means 9c, 10 or 26. After this the tools 2 needed at the work site, the working lights and a possible video camera are fixed to the work device 1, unless they were already fixed earlier, and they are also connected to the hydraulic system and control system of the apparatus. The work device 1 is also connected to a hydraulic powerpack 3 via hydraulic hoses 4 and electric cables 6.

When all the connections are ready, a command to ascend the pillar is given to the work device 1 with the remote controller 7, in which case the work device 1 ascends according to a predefined control logic and operating logic such that the traction rollers and guide rollers 11, 12 are tightened by the aid of the power means 9a around the pillar and the traction rollers 11 are rotated with the hydraulic drive machinery 11a until the work device 1 is at the right height for the work site. If the work device 1 needs to be rotated around the pillar so that the tools 2 could be brought to exactly the right point at the work site, the traction rollers 11 are inclined with the power means 14 in the ascending phase until the correct rotary position is achieved. If there is not enough time during the ascent to the work site to achieve the correct rotary position, the work device 1 is lowered slightly lower without any rotation, in which case the traction rollers 11 are not inclined, the traction rollers are inclined again and the work device 1 is again driven upwards. This type of straight downward drive and an upward drive rotating around the pillar is implemented as many times as needed to finally achieve the correct rotary position.

When the work device 1 is at the work site, the tools 2, working lights and possible video camera are used under remote control by the aid of the control unit 7, until the necessary task has been completed. After this a command to descend from the pillar is given to the work device 1 by the aid of the control unit 7, after which the work device 1 is detached from around the pillar and transferred to the next site.

The method and apparatus described above are well suited for e.g. the installation, servicing and disassembly of electricity lines, in which case the work is safe and the working on an electricity pillar does not cause danger to human life. In addition, the method and apparatus are also suitable for all kinds of other working that occurs on pillars or on posts. The solution according to the invention is suited for use for, inter alia, the cleaning and painting of lighting pillars and also for the repairing, cleaning and painting of beam structures of bridges made from metal beams. The apparatus comprises means for connecting the spraying pressure of the sprays used in painting and cleaning and the propagation speed of the apparatus on the pillar or beam to each other within certain limits such that the paint surface is made to be of even thickness and cleaning agent or solvent cleans as effectively as possible. In addition, the apparatus comprises means for adjusting and synchronizing the connection between the spraying pressure and the propagation speed of the apparatus.

In addition, the solution according to the invention is also suited for use for pruning erect trees and for cutting an erect trunk, when the tools to be used are selected to be suitable for this purpose.

It is obvious to the person skilled in the art that the invention is not limited solely to the example described above, but that it may be varied within the scope of the claims presented below. Thus, for example, the phases of the method can be different and in a different sequence to what is presented above.

It is further obvious to the person skilled in the art that the apparatus can also be structurally different to what is described above. For example, the fixing of the tools to the tool base can be implemented in a different manner. One way is to fix the tools with suitable bands to e.g. a cross-sectionally round or rectangular tool base.

1. A method for conveying tools to a work site with a work device traveling along an elongated object, such as along a pillar, a post, a beam, a steel rope being a support rope, or a tree, and for processing the work site, wherein the method comprises at least one or more of the following phases:
a work device consisting of at least two frame halves is disposed around the elongated object and the frame halves are locked to each other
one or more tools to be used at the work site are fixed to the work device
the work device is connected at least to a power means, such as to an accumulator traveling along with the work device, to an electric and/or hydraulically separate movable hydraulic powerpack
the work device is controlled by the aid of the power to be received from an accumulator and/or from a hydraulic powerpack traveling along with the work device and by the aid of the remote control transmitted by the control unit to rise up along an elongated object to a work site when moved by at least one traction means
the work device is rotated around the elongated object when the traction means are rotating by inclining the traction means by the aid of power means.

2. The method according to claim 1, wherein the work device is moved along the elongated object by the aid of a rubber-surfaced traction roller rotating around an axis, which traction roller is pressed against the elongated object by the aid of a hydraulic power means.

3. The method according to claim 1 or 2, wherein the work device is moved along the elongated object by pressing the traction rollers and guide rollers on both frame halves towards each other from opposite sides of the elongated object by the aid of power means and by rotating the traction rollers around their axes by the aid of hydraulic power means.

4. The method according to claim 1, wherein the work device is rotated around the elongated object when the traction means are rotating by inclining the traction means by the aid of power means and, if necessary, the rotational movement is renewed by driving the work device downwards without rotation and back upwards rotating around the elongated object until the desired rotary position is achieved.

5. The method according to claim 1, wherein the work device is controlled, if necessary, to the work site and working with the tools is controlled at the work site by the aid of a video camera fixed to the work device, which video camera is controlled with a control unit operating with remote control.

6. An apparatus for conveying tools to a work site along an elongated object, such as along a pillar, a post, a beam or a tree, which apparatus is provided with at least a control system and comprises at least a work device connected to the control system and moving along an elongated object, said work device comprising a frame and moving means for controlling the work device up and down along the elongated object, wherein the frame of the work device consists of two frame halves to be disposed around the elongated object and to be locked to each other, to which frame halves a tool base is fixed for at least the tools needed at the work site.

7. The apparatus according to claim 6, wherein the top part of a frame half comprises a tool base curving around the elongated object, which tool base comprises fixing means, such as a fixing groove or suitable quick-fastening means for the easy and rapid attachment and detachment of at least tools.

8. The apparatus according to claim 6 or 7, wherein the moving means of the work device are disposed in each frame half and they comprise at least one traction roller rotating around its axis as well as a hydraulic power means rotating the traction roller, which power means is connected to the control system of the apparatus.

9. The apparatus according to claim 6, wherein for rotating the work device around the elongated object the apparatus is provided with electrical or hydraulic power means disposed in the frame halves of the work device as well as with movable bearing housings fixed to the power means, in which bearing housings the second end of the shaft of the traction rollers is mounted.

10. The apparatus according to claim 6, wherein at least the surface material of the traction rollers is of rubber or of another corresponding material possessing sufficient friction, and in that the traction rollers are conical such that the diameter of the rollers is largest at the ends of the rollers and the diameter decreases conically towards the center point in the axial direction of the rollers.

11. The apparatus according to claim 6, wherein the apparatus comprises a separate, easily-movable hydraulic powerpack, from which the work device and the tools receive the necessary hydraulic control, and which hydraulic powerpack comprises a current source, such as e.g. a generator and/or battery pack, which current source is connected with electric cables to the work device for supplying the necessary control current and operating current to the devices of the apparatus that need electricity, such as to the control system, to the working lights and to the video camera.

12. The apparatus according to claim 6, wherein the apparatus comprises a separate rechargeable accumulator that is easily fixed to the work device and easily detached from the work device, from which accumulator the work device and the tools receive the necessary operating power and the necessary control current and operating current for the other devices of the apparatus that need electricity, such as for the control system, for the working lights and for the video camera.

13. The apparatus according to claim 6, wherein the apparatus comprises means for connecting the spraying pressure of the sprays used in painting and cleaning and the propagation speed of the work device on the pillar or beam to each other, and in that the apparatus comprises means for adjusting and synchronizing the connection between the spraying pressure and the propagation speed of the work device.

14. The apparatus according to claim 6, wherein the control system of the apparatus comprises control logic, which comprises means, by the aid of which the control logic is arranged to effect in the rising phase the compression of the traction rollers and of the guide rollers against the surface of the elongated object and the rotation of the traction rollers around the axes of the traction rollers with power means as well as the inclination of the axes of the traction rollers with power means during the rotation of the traction rollers.

15. The apparatus according to claim 6, wherein the work device comprises a remote control receiver for controlling the work device and the tools fixed to it and also the functions of the actuators by the aid of a remote controller.

16. Use of the apparatus according to claim 6 for installing, servicing and disassembling electricity lines.

17. Use of the apparatus according to claim 6 for repairing, cleaning or painting pillars, posts or beams.

18. Use of the apparatus according to claim 6 for trimming erect trees and cutting the trunk of erect trees.
